(19) United States
(12) Patent Application Publication
(10) Pub. No.: US 2008/0169988 A1
(43) Pub. Date: Jul. 17, 2008

(54) Lightweight, conformal, wideband airframe antenna

(76) Inventors: Michael A. Deaett, North Kingstown, RI (US); Willam H. Weedon, Warwick, RI (US); Bryan L. Hauck, West Warwick, RI (US)

Correspondence Address: MAURICE M. LYNCH, 429 CHURCH AVENUE, WARWICK, RI, 02885, US

(21) Appl. No.: 11/653,472

(22) Filed: Jan. 16, 2007

(51) Int. Cl. H01Q 1/28

(52) U.S. Cl. 343/708

(57) ABSTRACT

A conformal antenna comprising: an electrically neutral airframe; metalized fabric covering said airframe; and transmission lines attached to said metalized fabric to connect to a transceiver.

### FIELD OF THE INVENTION

This invention relates to a novel wideband conformal antenna and methods for constructing such.

### BACKGROUND OF THE INVENTION

Wideband conformal antennas are of much interest to the aircraft manufacturing community since they allow a lower drag replacement for the multiplicity of antennas currently employed on aircraft constructed according to the current art.

In the past, antenna systems have been after-thought appendages to existing aircraft. Following another paradigm to produce optimal performance, this invention uses airframe embeddable technology to provide conformal load bearing antenna structures (CLAS) during airframe design.

Current methods of producing conformal antennas are based on the composite construction found on heavily wing-loaded, high speed aircraft. There is however a need for small, low speed aircraft that have a long endurance. These same aircraft are required to have wideband antennas to support on-board systems such as radars. These antennas must be conformal to produce efficient, low drag airframes. They must also be lightweight to reduce fuel consumption.

There are no small, lightweight, conformal antennas with adequate RF performance. There are low efficiency trailing wires and very small and heavy ferrite-loaded loop antennas with inadequate RF performance. To achieve adequate RF performance with small aircraft at currently allocated frequencies of operation requires antennas that have a dimension equaling the size of the aircraft; for example, a length that is equal to the wing span or length of the fuselage. Such antennas must be constructed of very lightweight material that can be incorporated into airframes during manufacturing.

An additional requirement is that the antennas must be broadband; that is, the operating bandwidth must be significant percentage of the mean antenna frequency of operation. The current method of providing such an antenna capability is to attach many antennas to the aircraft with resulting weight, cabling and maintenance problems.

This invention is particularly useful for small, radio-controlled planes that do not have the size and payload capacity to support larger heavier antennas such as those currently in use.

The inventors have experience with lightweight antennas composed of non-woven fabrics in different applications. See application Ser. Nos. 11/113,222 and 11/305,677. The former application discusses a fabric patch antenna comprising non-woven fabric for support calendered with a metallized fabric provided for conductivity. This current invention could also be applied to the fabric patch antenna. The latter application demonstrates how to construct a strip-line antenna from the same materials. This could also be used in conjunction with this current application.

### SUMMARY OF THE INVENTION

It is, therefore, the object of this invention to provide a microwave antenna constructed from lightweight and strong textile materials by textile technology means.

It is a further object of this invention to provide a means of constructing antennas that are integral parts of an airframe.

It is a further object of this invention to produce multifunctional antennas that can be used by a variety of payload packages.

It is a further object of this invention to provide a means of producing light weight conformal antennas.

It is a further object of this invention to provide a conformal antenna with broadband performance.

It is a further object of this invention to provide a small aircraft conformal antenna capable of providing vertical and horizontal polarization performance.

Another object of this invention is to demonstrate lightweight, conformal antenna design using scaled model airframes with scaled motors to design said conformal antennas.

The subject invention results from the realization that a lightweight conformal antenna comprising conductive fabrics attached to an airframe and coated with a sealer or a urethane paint to provide structural integrity and improved aerodynamic characteristics is an improvement for lightweight unmanned radio-controlled aircraft.

This invention features an antenna constructed of components comprised of both conductive and nonconductive fabrics that are integral parts of the airframe.

One embodied of this invention additionally features an antenna composed of one or more conductive fabric elements that are parasitically coupled to produce broadband response performance.

In the primary embodiment of this application, metalized or conductive fabric is arranged as either a dipole or monopole antenna over the wings, tail assembly or fuselage of a SUAV. The metalized or conductive fabric is either applied directly to the airframe or is stitched, glued or otherwise attached the fabric covering the airframe, connected to a transmitter, receiver or transceiver and a sealant or epoxy is applied to the antenna to provide strengthening to the fabric. One or more parasitic elements of conductive or metalized fabric are placed adjacent to the conductive element to provide increased directivity or broader bandwidth.

### BRIEF DESCRIPTION OF THE DRAWINGS

Other objects, features and advantages will occur to those skilled in the art from the following description of a preferred embodiment and the accompanying drawings, in which:

FIG. 1 a diagram showing a lightweight wide band segmented dipole airframe antenna in the wing of a small radio controlled airplane.

FIG. 2a is a diagram of an existing wideband segmented dipole antenna used for vehicles.

FIG. 2b is a diagram of a segmented wideband segmented dipole antenna on a test stand.

FIG. 3 is a graph showing the VSWR performance of the antenna of FIG. 2.

FIG. 4 is a picture of a small radio controlled airplane.

FIG. 5 is a picture of the airplane of FIG. 4 with a lightweight wing antenna installed.

FIG. 6 Estimated graphic representation of VSWR vs. Frequency of a test fabric conformal wing dipole antenna.

FIG. 7 is a graph of the dipole wing antenna measured azimuth response.

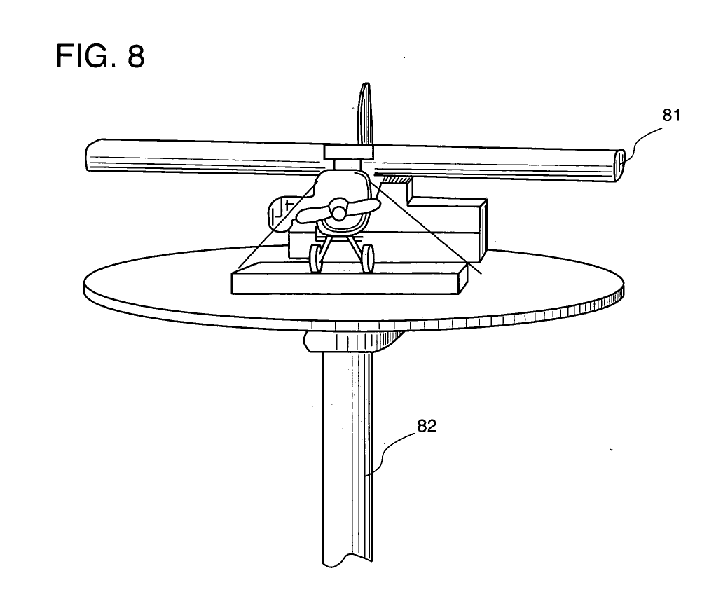

FIG. 7 is a picture containing two views of an airplane surrogate truss structure used for scaled model testing various lightweight airframe antennas.

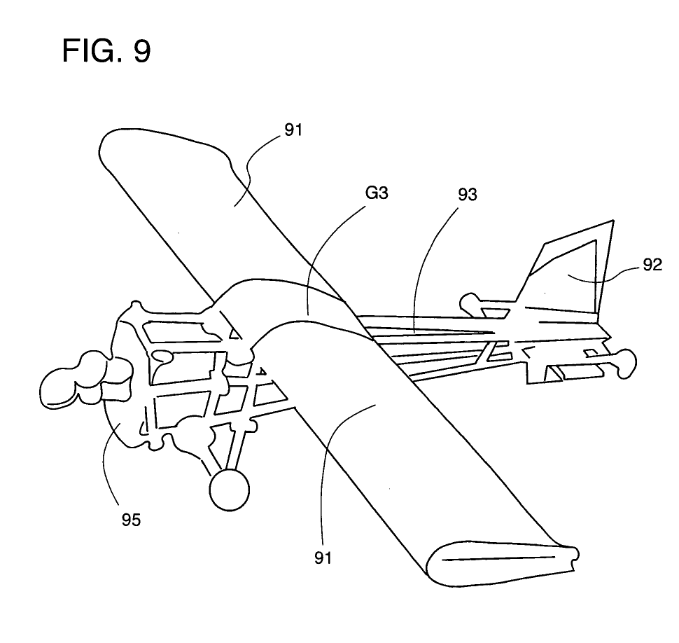

FIG. 8 is a picture showing a lightweight vertical stabilizer antenna.

FIG. 9 is a graph showing the angular response of the antenna of FIG. 8.

FIG. 10 shows two embodiments of conformal tail antennas.

FIG. 11 is a graph showing the response of the wing antenna of FIG. 7 to vertically polarized radiation with a wingtip azimuth arrival angle and various degrees of wing bank.

FIG. 13 is a picture of a non-woven fabric containing an antenna patch implanted by calendering during manufacturing.

FIG. 14 is a cross section view of a conformal segmented dipole wing antenna.

### DISCLOSURE OF THE PREFERRED EMBODIMENT

The preferred embodiment of this invention is a lightweight, broadband conformal antenna. There are several elements in the construction of this type of antenna. First, is the initial design of the antenna which the inventors achieved by using a scaled truss airframe construction with scaled motors to determine the shape, separations of panels and wiring of the antenna. The second element is the testing of the antennas in an anechoic chamber to evaluate beam patterns and performance. A third element is to evaluate different conductive fabrics with regards to their suitability in an aeronautical environment. The final elements are the attachment to the airframe, and the sealing of the conductive fabric if needed. The design of the broadband antenna is discussed first.

1.0 Design of Wideband Conformal Antennas Integrated with an Airframe

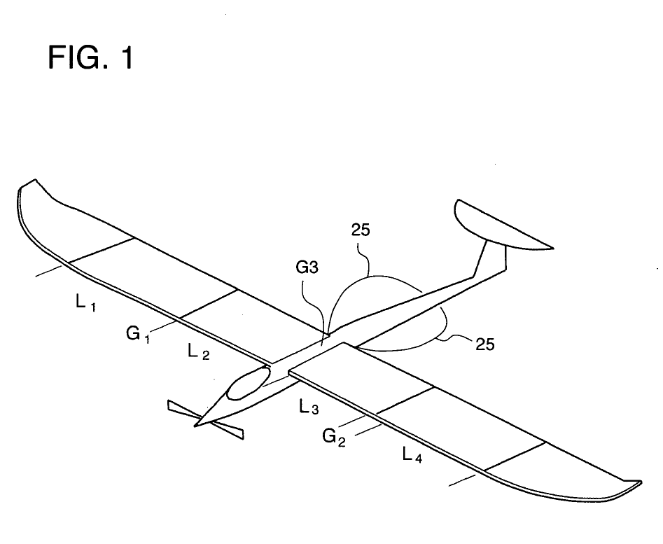

In this application a conformal antenna in FIG. 1 is comprised of four separate segments, but each segment is constructed by means of conductive fiber incorporated in the airframe fabric. The fabric is then attached to the airframe and is coated with a sealer and urethane paint for provide structural integrity and improved aerodynamics.

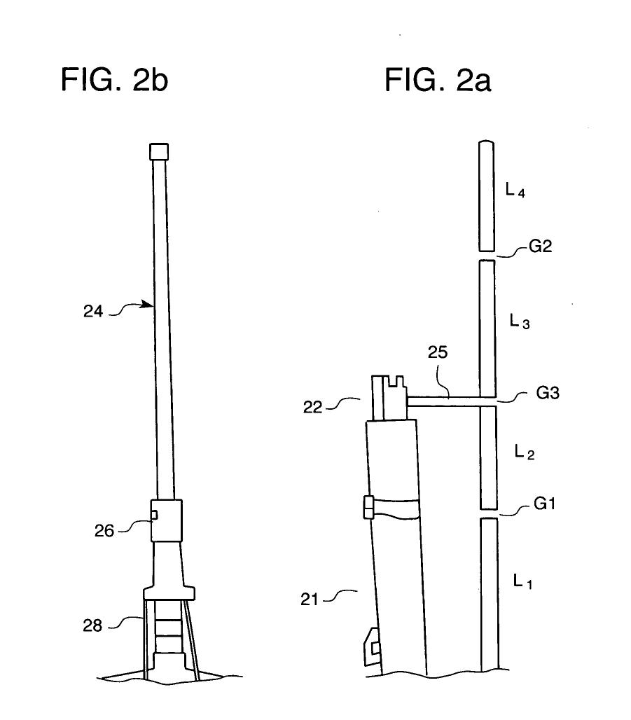

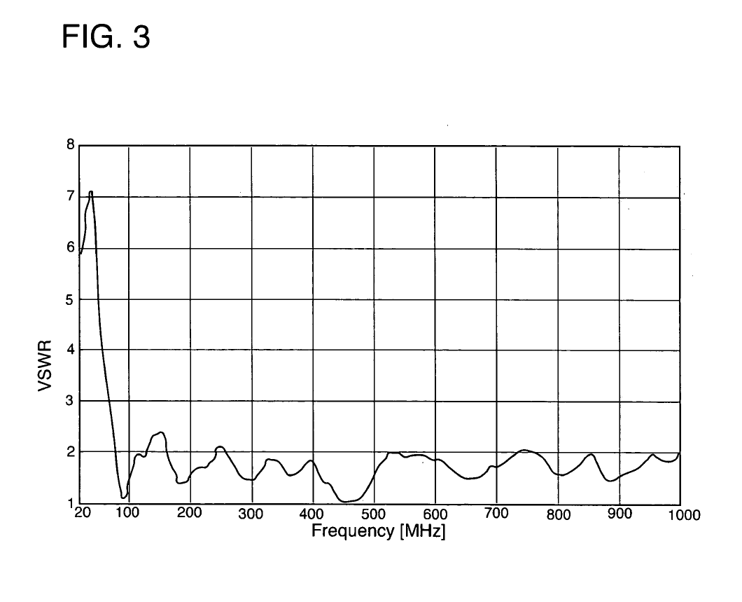

The arrangement of the conductive fibers in FIG. 1 is analogous to a four-segment, wideband, dipole, conformal wing antenna employed for transmitting and receiving microwave radiation as shown in FIGS. 2a and 2b. In the industry today conformal antennas are based on composite construction such as that found on heavily wing-loaded, high speed aircraft.

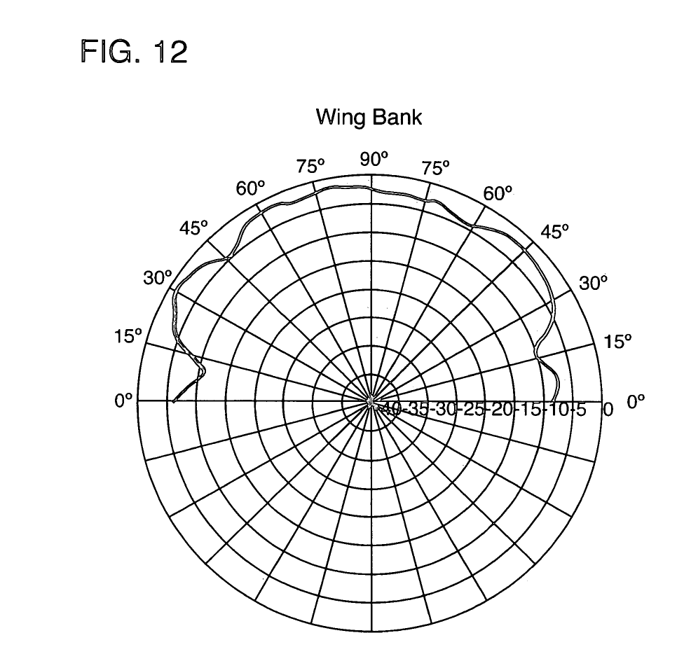

In the embodiment in FIG. 1, the fabric conformal antenna operates over a very wide frequency range; for example; this antenna may be designed to operate over frequencies from 65 MHz through 2 GHz. The center two segments labeled L2 and L3 are fed at the center or inside edges through an impedance matching network, 25. The impedance matching network and the two wing components are separated by the fuselage or center gap labeled G3. The outer two segments, labeled L1 and L4 are separated from the central two sections by gaps labeled G1 and G2. The shape of the antenna is determined primarily by aerodynamic performance considerations. The equivalent mean antenna diameter is usually two inches or more for the 65 MHz through 2 GHz frequency range. The equivalent mean diameter in this instance is determined by the size of the wing which provides the shape for the antenna. The optimal design parameters are determined empirically. For lower frequency operation, a longer overall length and larger equivalent mean diameter may be desirable. The overall wingspan is first determined from aerodynamic and flight profile performance objectives. If this wingspan proves too short after many design trials, then the wingspan is increased or the minimum operating frequency is increased. The length of each segment, L1 through L4, is determined iteratively. An initial trial used is four equal length segments, L1=L2=L3=L4. The gap between the segments L1 and L2 and between L3 and L4 is likewise empirically determined and is commonly between 1 mm and 12 mm. A starting value of 3 mm is commonly employed. It is also possible to adjust performance by using small trap circuits comprised of capacitors and or inductors between the gaps to change the frequency dependent distribution of currents. These design iterations are commonly conducted using prototypes and actual measurements of the voltage standing wave ratio (VSWR) and beam-patterns. An alternative also employed for simpler antennas is to model these antennas using a simulation tool such as AnSoft HFSS and to optimize the parameters with simulation. Although FIG. 1 is drawn with symmetric segments, it may be the case that an asymmetric antenna has better performance. Such asymmetric designs can produce the same VSWR performance but the beam pattern can be adjusted to maximize performance. Although not shown in equivalent detail, the tail monopole antenna, FIG. 10, is specified in a similar fashion.

Broadband antennas are designed with a particular interest in a set of frequencies within the total operational bandwidth. At those frequencies performance is most critical. By varying the equivalent mean diameter of the dipole antennas, the inter-segment coupling and other parameters, it is possible to achieve useful impedance matching over the entire frequency range. This same approach can be applied to fuselage mounted, parasitically coupled antennas as well.

### 2.0 Past Embodiments and RF Performance Evaluation

### 2.1 Radio Controlled Plane Wing Antenna at 325 MHz

The segmented dipole antenna employed in a past designs (FIG. 2a) is one meter in length and operate at frequencies from 65 MHz to 2 GHz with a VSWR of about three or less. FIG. 2 depicts this past design of a rigid segmented dipole antenna . . . . It is attached to a test stand, 21, and power source, 22, through a coaxial feed to a matching impedance network. The rest of the antenna is labeled the same way as FIG. 1 to show the relationship between the two antennas. FIG. 2b depicts the outer housing for the antenna displayed in FIG. 2a, with outside covering and support 24, connector 26 and a shock mounting 28.

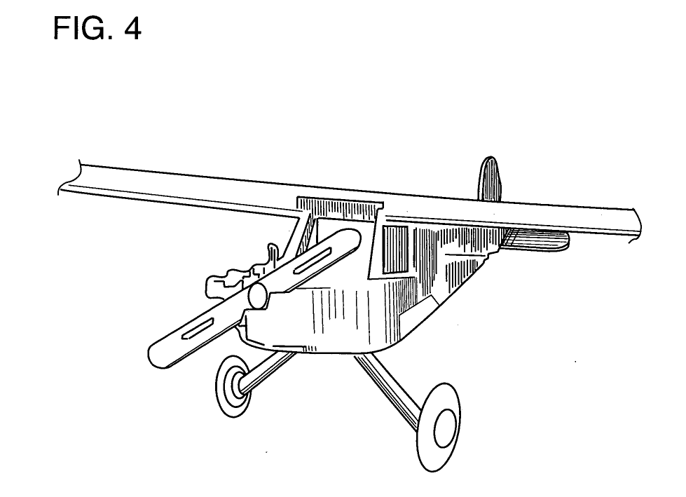

FIG. 3 depicts a graph plotting VSWR versus frequency with a ratio of 1 being optimal. This technology is a candidate for implementing wing and fuselage embedded antennas. With a longer wing, operation to a much lower frequency is possible.

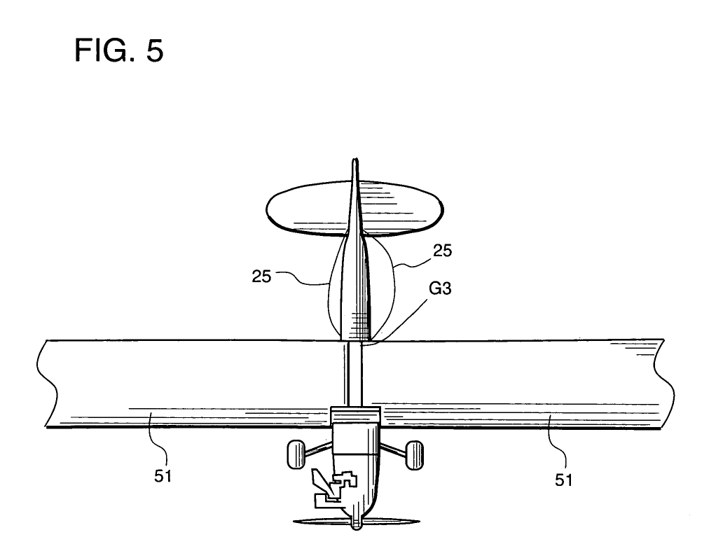

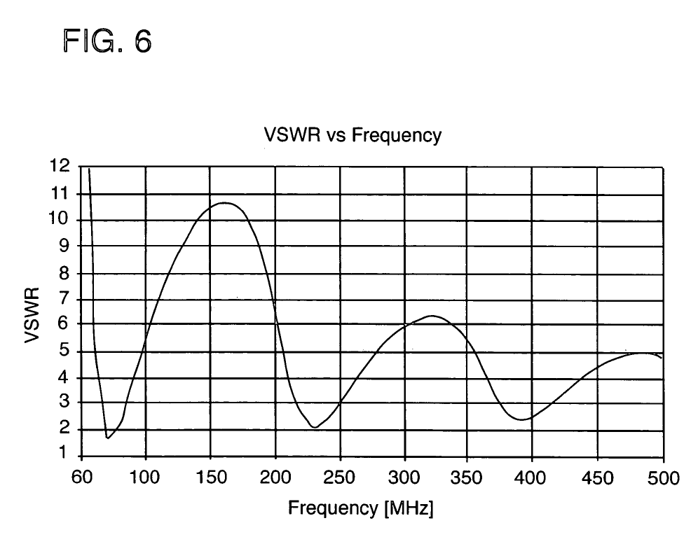

Experiments integrating antennas into small unmanned aerial vehicles (SUAV's) by covering the wings of radio controlled aircraft (FIG. 4) with conductive fiber mesh to form a dipole antenna, 51 in FIG. 5, were performed. This designed as a two element dipole used to compare the performance of wing-embedded designs with that of conventional dipoles. A separation between the two wings, G3 is the same as for the segmented dipole antenna. The coaxial feeds 25 were attached near the center of the wing and fed to a hybrid coupler to produce the antenna output. Antenna pattern measurements were then made on an outdoor test range. These measurements were made at a frequency of 325 MHz to rapidly produce experimental results. This frequency is within the intended operating band and the measurement system was configured for that frequency.

Measurements were made in 30° increments by rotating the antenna under test (AUT) relative to the fixed position of the transmit antenna. The transmit antenna was configured to be horizontally polarized to match the polarization of the antenna under test.

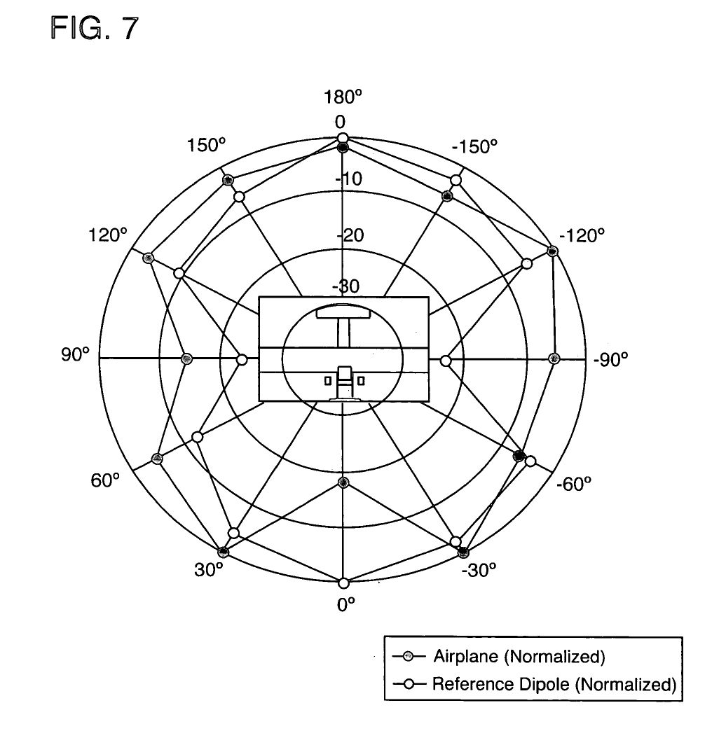

To examine the performance that might be attained by the conventional dipole antenna operating on the wings of the test SUAV, a cylindrical dipole was formulated with a circumference equal to that of the conductive fiber wing antenna. VSWR of this approximate antenna was analyzed using a simulation code. Laboratory measurements of the VSWR of the actual antenna were conducted with a network analyzer. The results are graphically represented in FIG. 6.

### 2.2 Scale Model Truss Airframe Embodiment and RF Performance Evaluation

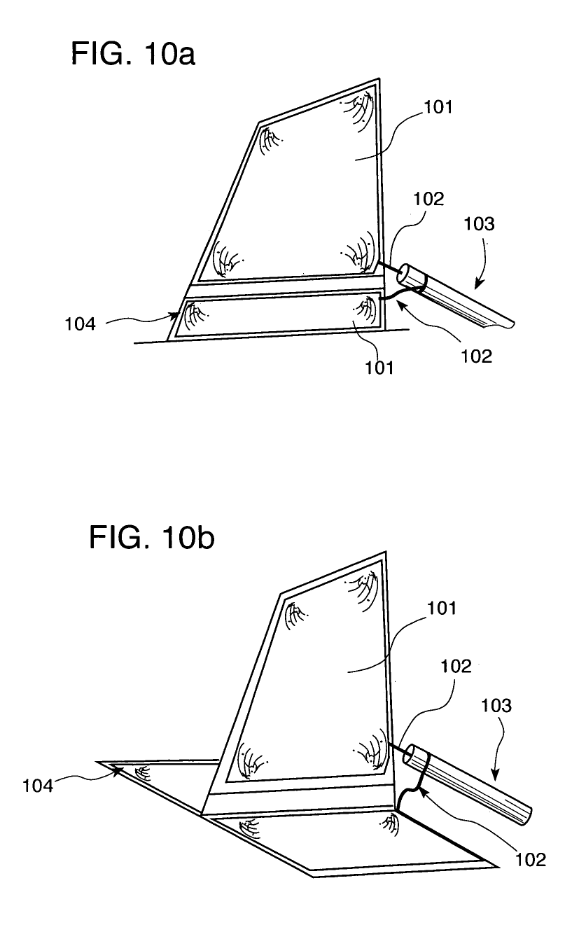

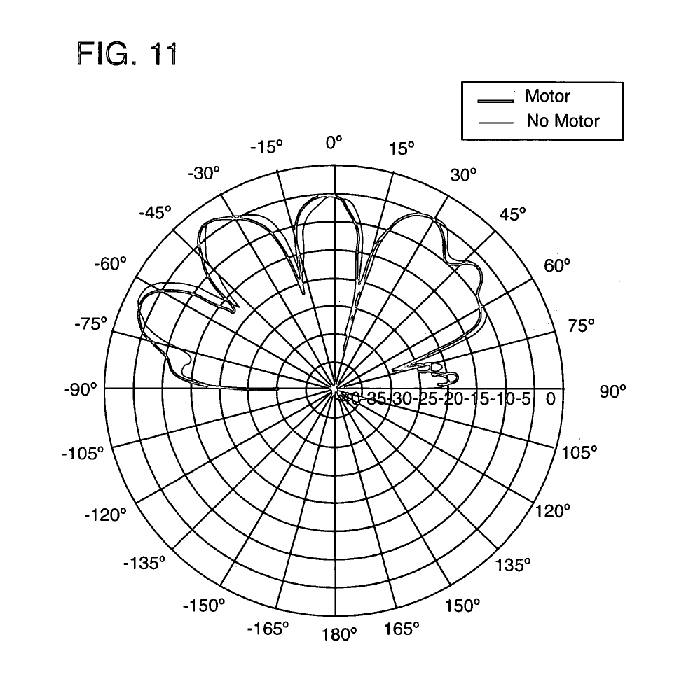

Scaled SUAV antenna design experiments were conducted to provide improvements beyond those afforded by current designs. Scaled truss model aircraft FIG. 8 was used in an anechoic chamber measurement facility to investigate low frequency performance. The wing of the aircraft is designated as 81 and the electrically neutral stand is 82. As depicted in FIG. 9, the truss airframe, 93 served to position the wings, 91 and tail stabilizer, 92. This truss model enabled conductive fiber to be positioned so that test measurements could be obtained. However, the motor used was a scaled electric motor, 95, since this propulsion system is most useful for the experiments as more scaled motors were available. The wings of the truss airframe in FIG. 9 depict a conductive fiber dipole antenna 91 with the shape of the airfoil and which has a span of 2 feet. The dipole antenna separation G3 is achieved by the physical presence of the fuselage. This dipole would, in later design phases, be segmented and iteratively improved.

To receive both horizontally and vertically polarized signals simultaneously, a banked aircraft maneuver can be used together with a wing antenna. To establish the loss due to the banked antenna, scale measurements were conducted with the truss wing airframe 91, from FIG. 9 and with a vertical conformal tail antenna with connections as shown in FIGS. 10a and b. To distinguish the assemblies in FIG. 10, a tail antenna with a ground plane, 104, in the vertical stabilizer is shown in FIG. 10(a) and a second embodiment with the ground plane, 104, in the horizontal stabilizer is shown in FIG. 10(b). Both designs are made with conductive fiber, 101. The ground planes of 10a and b are connected to feed lines, 102.

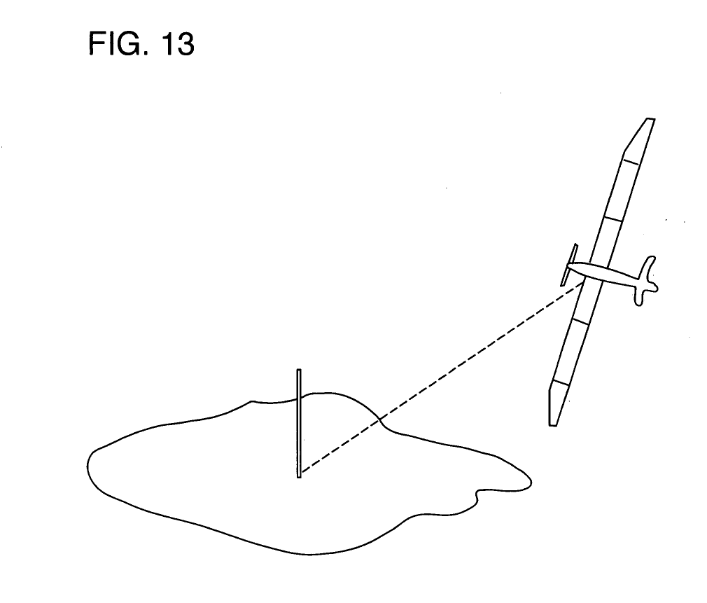

A series of beam-patterns is displayed in FIG. 11 for the vertical stabilizer tail shown in FIG. 10a. The beam patterns were measured including responses to vertically polarized radiation which is of interest for many applications. A tail antenna offers a significant response to a vertically polarized signal as can be seen in FIGS. 11 and 12. In FIG. 12, the graph displays the beam pattern readings for the truss model going through a simulated banking maneuver from 0 to 90 degrees. Since the beam patterns are broad, an aircraft can be expected to observe signals using such an antenna.

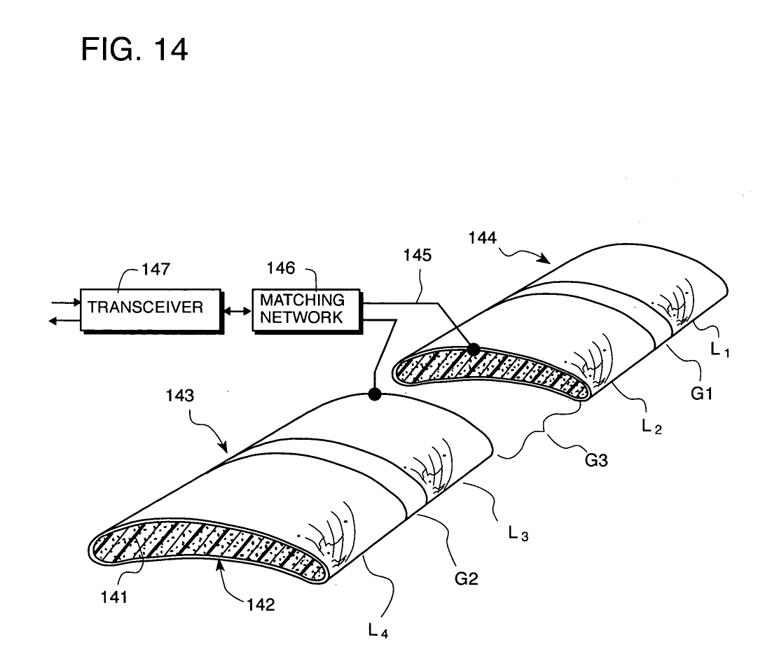

The measurement results for the wing antenna are shown in FIG. 12, and indicate that a 30 degree bank will produce an estimated 4.5 dB loss from a vertical receive antenna. A 45 degree maneuver can be expected to reduce the received signal response by about 2.0 dB. Since the wing-over, 90 degree of bank, maneuver converts the wing dipole into a vertically oriented antenna; see FIG. 13, there is no additional loss in this case. An interesting result is that the electric motor seemed to produce only minor interference. As mentioned above, earlier tests with an airplane using a gasoline engine were seen to produce significant changes in the pattern.

### 3.0 Conductive Fiber Materials for Conformal Antenna Construction

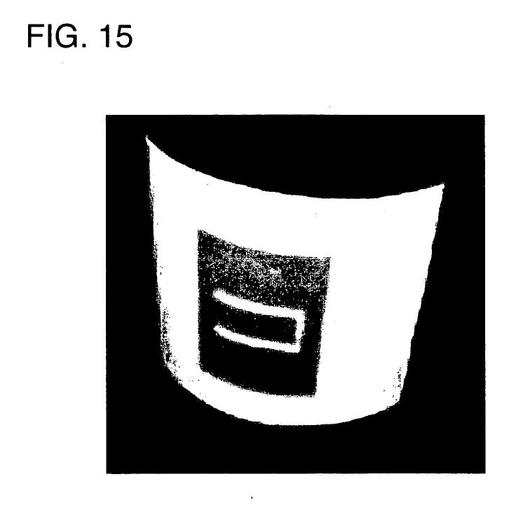

FIG. 14 is a cross section view of the conformal antenna in a segmented dipole mode. Here, the airframe 141 is covered with the conductive or metalized fabric, 142 on the port or left wing 143. The right or starboard wing is labeled 144. The segmented dipole portions of this antenna are labeled as in previous figures with the I1-4 and G1-3 designations. The feedlines 145 connect the antenna to the matching network, 146 which in turn is connected to a transceiver 147.

The enabling technology for this SUAV antenna is conductive fiber which is incorporated into both woven and non-woven airframe covering fabrics. One fiber proposed for this application, ShieldEx™ part number RTFK151, is a new and very lightweight version that was recently developed for space applications. The traditional use of fabric-over-frame construction to produce FAA certified utility and aerobatic class high performance manned aircraft is discussed below . . . . These same established methods can be used in conjunction with conductive fiber techniques such as the PolyFlex™ system to produce advanced SUAV's incorporating ultra-light CLAS structures.

There are three conductive fiber methods applicable to this problem. The first is to stitch conductive fibers into rip-stop DACRON covering fabric, CECONITE or other FAA certified airframe covering fabric. The conductive patterns that are stitched must be pre-distorted so that when the fabric is stretched over the frame, the intended physical dimensions are obtained. The resulting airframe antenna is an integral part of the skin and is very rugged and lightweight and is a dependable standard aircraft construction. A second method is to glue patterns of conductive fabric over the airframe. This method is quick and the antennas are dimensionally correct but the result is not rugged enough for operational aircraft. Instead, this method was used for experiments to evaluate CLAS airframe options (examples below). The third method is to substitute non-woven fabric for the conventional CECONITE or Poly-Flex fabric. This non-woven is a light and strong fabric similar to TYVEK, but has incorporated within it patterns of conductive fibers. The layering effect of this method is shown in FIG. 14 where the conductive fabric (stand alone conductive fabric or conductive fabric attached to non-conductive fabric) 11 is stretched and attached to the airframe 12.

What is claimed is:

1. A conformal antenna comprising:
an electrically neutral airframe;
metalized fabric covering said airframe; and
transmission lines attached to said metalized fabric to connect to a transceiver.

2. A conformal antenna as described in claim 1 wherein the metalized fabric is coated with a resin for strength.

3. The coating described in claim 2 is from a group of resins that includes, but is not limited to: polyester, ester, cyanate ester or similar resins.

4. A conformal antenna as described in claim 1 wherein the airframe comprises of a left wing and a right wing;
the metalized fabric is affixed to the top and bottom of said right wing and said left wing with a separation between the said two wings formed by a fuselage;
a transmission line attached to the metalized fabric affixed to said left wing and a transmission line attached to the metalized fabric affixed to said right wing; and
the transmission line attached to the metalized fabric on said left wing is connected to a transceiver as is the transmission line attached to the metalized fabric on said right wing is connected to a transceiver forming a dipole antenna.

5. A conformal antenna as described in claim 1 wherein the airframe is a vertical stabilizer;
the metalized fabric is affixed to the upper portion and both sides of said vertical stabilizer, said metalized fabric on the upper portion of said vertical stabilizer acts as an antenna;
a conductor to transmission lines attached to said metalized fabric attached to upper portion of said stabilizer;
a second section of metalized fabric affixed to both sides of the lower portion of said vertical stabilizer; and
a second conductor attached to said second section of metalized fabric, said lower section acts as a ground plane.

6. A conformal antenna as described in claim 1 wherein the airframe is a vertical stabilizer and a horizontal stabilizer;
metalized fabric is attached to both sides of the vertical stabilizer;
a transmission line is attached to said metalized fabric attached to said vertical stabilizer;
said transmission line is attached to a transceiver;
metalized fabric is attached to the upper and lower surfaces of said horizontal stabilizer;
a transmission line is attached to said metalized fabric attached to said horizontal stabilizer;
said transmission line is attached to a transceiver; and
the resulting structure forms an antenna and ground plane.

7. A conformal antenna as described in claim 1 wherein the airframe is comprised of a left wing, a right wing and a fuselage;
metalized fabric is affixed to the upper and lower surfaces of the inboard portion of the left wing and the right wing;
a transmission line is connected to the metalized fabric on the inner portion of the left wing, the fuselage acts as a non-conductive gap between said metalized fabric on the inboard portion of the left wing and the right wing;
a transmission line is connected to the metalized fabric on the inner portion of the right wing;
said transmission lines attached to the metalized fabric on the inner portion of the left wing and the metalized fabric on the inner portion of the right wing are attached to a transceiver;
a non-conductive gap is positioned adjacent to each of the metalized fabric sections attached to the inboard portion of the left wing and the right wing; and
adjacent to the non-conductive gap, metalized fabric is affixed to the upper and lower surfaces of the outboard portion of the left wing and the right wing forming a segmented dipole antenna.
